(19) United States
(12) Patent Application Publication
(10) Pub. No.: US 2015/0160664 A1
(43) Pub. Date: Jun. 11, 2015

(54) EXPANSION VALVE

(71) Applicant: TGK CO., LTD., Toyko (JP)

(72) Inventor: Takeshi KANEKO, Toyko (JP)

(21) Appl. No.: 14/558,664

(22) Filed: Dec. 2, 2014

(30) Foreign Application Priority Data
Dec. 9, 2013 (JP) 2013-254264

(51) Int. Cl. G05D 23/185; F25B 41/06

(52) U.S. Cl. CPC G05D 23/1852; F25B 41/062

(57) ABSTRACT

An expansion valve according to an embodiment includes a power element, a metal seal part, and an elastic seal part. The power element has a housing, formed of a metal different from a kind of metal constituting a body, and a drive section, provided within the housing, which generates a drive force used to open and close a valve section. And the power element is fixed to the body in a manner such that the housing closes an opening end of the body. The metal seal part is provided between the body and the housing, and seals between an inside and an outside of the body by a deformation in a metal. The elastic seal part is provided between the body and the housing, and seals between an inside and an outside of the housing in such a manner as to surround the periphery of the metal seal part.

### CLAIM OF PRIORITY

This application claims priority to Japanese Patent Application No. 2013-254264, filed Dec. 9, 2013, and is incorporated herein by reference.

### BACKGROUND OF THE INVENTION

1. Field of the Invention

The present invention relates to an expansion valve and, more particularly to a seal structure for preventing the leakage of refrigerant.

2. Description of the Related Art

A refrigeration cycle in an automotive air conditioner is generally configured such that the refrigeration cycle includes a compressor, a condenser, a receiver, an expansion valve, and an evaporator. The compressor compresses a circulating refrigerant. The condenser condenses the compressed refrigerant. The receiver separates the condensed refrigerant into a gas and a liquid. The expansion valve throttles and expands the separated liquid refrigerant and delivers it by turning it into a spray. Then the evaporator evaporates the misty refrigerant and thereby cools the air inside a vehicle's passenger compartment by the evaporative latent heat.

Used as the expansion valve is a thermostatic expansion valve that senses the temperature and pressure of refrigerant at an outlet side of the evaporator such that, for example, the refrigerant led out from the evaporator has a predetermined degree of superheat and that controls the flow rate of refrigerant delivered to the evaporator by opening and closing a valve section. This expansion valve includes a body formed with a first passage for passing the refrigerant flowing from the receiver to the evaporator and a second passage for passing the refrigerant returned from the evaporator and then supplying the refrigerant to the compressor. A valve hole is formed midway in the first passage. And a valve element is provided such that the flow rate of refrigerant flowing to the evaporator is regulated by touching and leaving this valve hole.

Provided at an end of the body is a power element that senses the temperature and pressure of refrigerant flowing through the second passage and controls the valve opening degree of the valve section. This power element has a housing, which is so mounted as to seal an opening end of the body, and a pressure-sensing member, which partitions the interior of the housing into a hermetically sealed space and an open space. The hermetically sealed space constitutes a reference pressure chamber, and the open space communicates with the second passage. The drive force of the power element is produced when the pressure-sensing member is displaced by sensing the temperature and the pressure of refrigerant flowing through the second passage, and the thus produced drive force thereof is transmitted to the valve element by way of a shaft. The shaft extends in such a manner as to move across the second passage and reach the first passage and is slidably supported by an insertion hole formed in a partition that separates the first passage from the second passage.

In such an expansion valve, an elastic sealing member, such as an O-ring, is generally provided in a joint part of the housing of the power element and the body. The elastic sealing member suppresses an adverse effect of the leakage of refrigerant, if any, on an external environment. Aside from such an elastic seal, a metal seal is used where the metals are press-bonded to each other (see Reference (1) in the following Related Art List, for instance). Press-bonding the housing and the body attempts to eliminate the sealing member such as the O-ring and reduce the manufacturing cost of the expansion valves.

### RELATED ART LIST

(1) Japanese Unexamined Patent Application Publication No. 2012-202555.

According to the verification conducted by the inventor of the present invention, it had been found that such a metal seal has a relatively short operating life and therefore the sealing property of the metal seal is not sufficiently reliable. In other words, the body is generally formed of an aluminum alloy because of easy moldability, and the housing of the power element is oftentimes formed of stainless steel in terms of secured strength and the like. That is, the body and the housing are formed of different kinds of metals, respectively. Thus, when moisture entering from the outside sticks to the joint part of the body and the housing, an electric potential difference occurs therebetween and an electric corrosion is caused thereby. This may possibly cause a deficit in the joint part and therefore the adequate sealing property may not be attained. At the same time, the conventional elastic seal is made of resin material such as the O-ring and this makes it difficult to completely prevent the refrigerant from being permeated and finally leaked. Thus, there is a limit in preventing the leakage of refrigerant.

### SUMMARY OF THE INVENTION

The present invention has been made in view of the foregoing problems, and one of purposes thereof is to improve the sealing capability at the joint part of a power element and a body in an expansion valve.

In order to resolve the aforementioned problems, one embodiment of the present invention relates to an expansion valve that throttles and expands refrigerant introduced from an upstream side of a refrigeration cycle by allowing the refrigerant to pass through a valve section so as to deliver the refrigerant to a downstream side thereof. The expansion valve includes: a metallic body having a lead-in port through which the refrigerant is led in, a lead-out port through which the refrigerant is led out, and a valve hole formed in a refrigerant passage joining the lead-in port to the lead-out port; a valve element that opens and closes the valve section by moving toward and away from the valve hole; a power element having a housing formed of a metal different from a kind of metal constituting the body and a drive section, provided within the housing, which generates a drive force used to open and close the valve section, wherein the power element is fixed to the body in a manner such that the housing closes an opening end part of the body; a metal seal part, provided between the body and the housing, which seals between an inside and an outside thereof by a deformation developed in a metal; and an elastic seal part, provided between the body and the housing, which seals between an inside and an outside thereof in such a manner as to surround a periphery of the metal seal part.

By employing this embodiment, as for the joining of the housing of the power element and the body, the metal seal part is provided inside, whereas the elastic seal part is provided outside. This configuration and arrangement prevent the refrigerant from being permeated and then leaked to the outside space. At the same time, the elastic seal part prevents moisture in the outside space from entering the metal seal part. As a result, the electric corrosion at the joint part of the housing and the body is prevented. In other words, by employing this embodiment, a double structure not assumed in the conventional practice is used where the metal seal part and the elastic seal part provided inside and outside, respectively, are used in combination, so that the sealing property at the joint part of the power element and the body can be improved.

### BRIEF DESCRIPTION OF THE DRAWINGS

FIG. 1 is a cross-sectional view of an expansion valve according to a first embodiment of the present invention;

FIG. 2 is a bottom view of an expansion valve;

FIGS. 3A to 3C show structures of seal parts and their peripheries;

FIGS. 4A to 4C show structures of seal parts and their peripheries according to a second embodiment; and

FIGS. 5A to 5C show structures of seal parts and their peripheries according to a third embodiment.

### DETAILED DESCRIPTION OF THE INVENTION

The present invention will now be described in detail based on preferred embodiments with reference to the accompanying drawings. This does not intend to limit the scope of the present invention, but to exemplify the invention. All of the features and the combinations thereof described in the embodiment are not necessarily essential to the invention.

In the following description, for convenience of description, the positional relationship in each structure may be expressed according to how each component is depicted in Figures. Note that the almost identical components are given the identical reference numerals in the following embodiments and their modifications and that the repeated description thereof will be omitted as appropriate.

### First Embodiment

The present embodiment is a constructive reduction to practice of the present invention where an expansion valve according to the preferred embodiments is used as a thermostatic expansion valve applied to a refrigeration cycle of an automotive air conditioner. The refrigeration cycle in the automotive air conditioner is configured by including a compressor, a condenser, a receiver, an expansion valve, and an evaporator. Here, the compressor compresses a circulating refrigerant. The condenser condenses the compressed refrigerant. The receiver separates the condensed refrigerant into a gas and a liquid. The expansion valve throttles and expands the separated liquid refrigerant and delivers it by turning it into a spray. The evaporator evaporates the misty refrigerant and thereby cools the air inside a vehicle's passenger compartment by the evaporative latent heat. A detailed description of each component except for the expansion valve in this refrigeration cycle is omitted in the following.

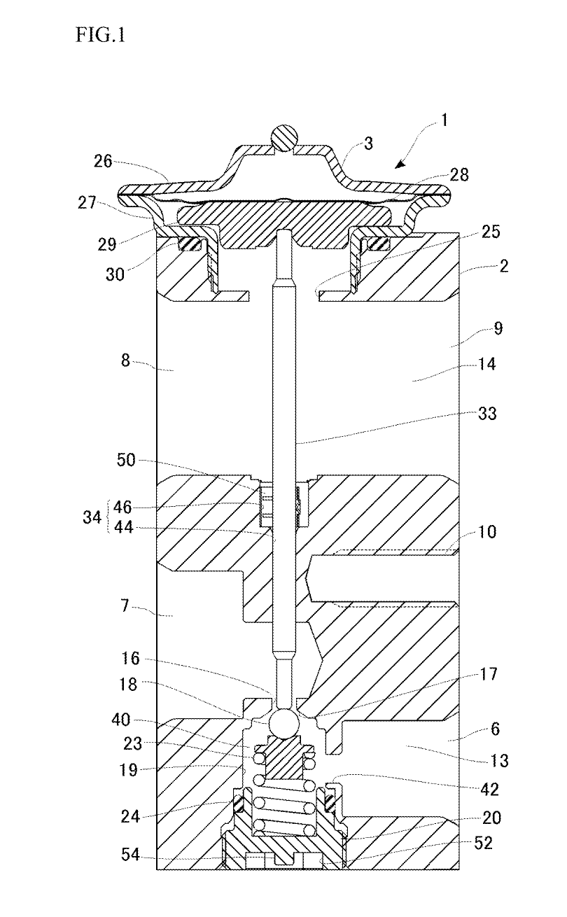

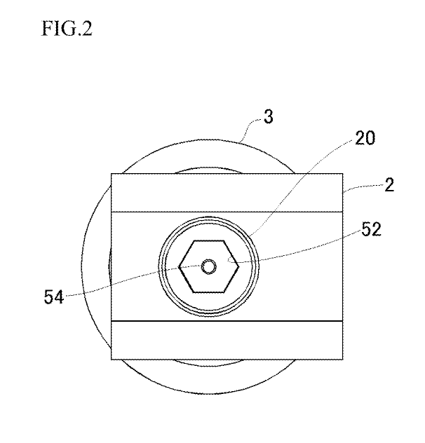

FIG. 1 is a cross-sectional view of an expansion valve according to a first embodiment of the present invention. FIG. 2 is a bottom view of the expansion valve. As shown in FIG. 1, an expansion valve 1 has a body 2. This body 2 is formed such that a member, which is obtained by extrusion-molding a raw material made of aluminum alloy, is subjected to a predetermined cutting work. This body 2, which is prismatic in shape, is provided with a valve section. This valve section, which throttles and expands the refrigerant, is formed inside the body 2. A power element 3, which functions as a temperature-sensing section, is provided at a longitudinal end of the body 2.

The body 2 has a lead-in port 6, a lead-out port 7, a lead-in port 8, and a lead-out port 9 on sides thereof. The lead-in port 6 receives a high-temperature and high-pressure liquid refrigerant from a receiver side (condenser side). Through the lead-out port 7, a low-temperature and low-pressure refrigerant, which is throttled and expanded by the expansion valve 1, is supplied to the evaporator. The lead-in port 8 receives the refrigerant evaporated by the evaporator. Through the lead-out port 9, the refrigerant, which has passed through the expansion valve 1, returns to the compressor side. A screw hole 10, through which a not-shown stud bolt used to mount the piping can be studded, is formed between the lead-in port 6 and the lead-out port 9.

In the expansion valve 1, a first passage 13 is configured by the lead-in port 6, the lead-out port 7, and a refrigerant passage connecting theses ports. A valve section is provided in a middle part of the first passage 13. The refrigerant introduced from the lead-in port 6 is throttled and expanded through this valve section and then turned into a spray so as to be supplied to the evaporator through the lead-out port 7. Also, a second passage 14, which corresponds to “return passage”, is configured by the lead-in port 8, the lead-out port 9, and a refrigerant passage connecting these ports. The second passage 14 extends straight, and the refrigerant is led in through the lead-in port 8 and then delivered to the compressor through the lead-out port 9.

A valve hole 16 is provided in a middle part of the first passage 13 in the body 2, and a valve seat 17 is formed by an opening end edge on a lead-in port 6 side of the valve hole 16. A valve element 18 is so placed as to face the valve seat 17 from a lead-in port 6 side. The valve element 18 is constructed such that a spherical ball valve element, which closes and opens the valve section by touching and leaving the valve seat 17, respectively, is joined to a valve element support that supports the ball valve element from below.

In a lower end part of the body 2, a communication hole 19, which communicates to and from the body 2, is formed in a direction perpendicular to the first passage 13, and a valve chamber 40, which contains the valve element 18, is formed by an upper half of the communication hole 19. The valve chamber 40 communicates with the valve hole 16 at an upper end of the valve chamber 40, and the valve chamber 40 communicates with the lead-in port 6 on a lateral side of the valve chamber 40 through a small hole 42. Thereby, the valve chamber 40 constitutes a part of the first passage 13. The small hole 42 is formed such that the cross section of part of the first passage 13 is locally narrowed, and the small hole 42 is open into the valve chamber 40.

In a lower half of the communication hole 19, an adjustment screw 20 (which corresponds to “adjustment member”) is screwed in such a manner as to seal the communication hole 19 from the outside. A spring 23, which biases the valve element 18 in a valve closing direction, is set between the valve element 18 (more precisely, the valve element support) and the adjustment screw 20. The spring load of the spring 23 can be adjusted by a screwing amount of the adjustment screw 20 into the body 2. An O-ring 24, which is used to prevent the leakage of refrigerant, is set between the adjustment screw 20 and the body 2.

In an upper end part of the body 2, a communication hole 25, which communicates to and from the body 2, is formed in a direction perpendicular to the second passage 14, and the power element 3 (which corresponds to “temperature-sensing section”) is screwed in such a manner as to seal off the communication hole 25. The power element 3 is configured such that a diaphragm 28 formed of a sheet metal is held between an upper housing 26 and a lower housing 27 and such that a disk 29 is disposed on a lower housing 27 side. The upper housing 26 and the lower housing 27 are welded along the outer periphery thereof, thereby constituting an entire housing of the power element 3. Both the upper housing 26 and the lower housing 27 are obtained by press-forming the stainless steel. Thus, the housing of the power element 3 has a higher degree of hardness than that of the body 2.

A gas used to sense the temperature is filled in a hermetically sealed space enclosed by the upper housing 26 and the diaphragm 28. In other words, the diaphragm 28 partitions the interior of the housing of the power element 3 into the hermetically sealed space and an open space. The hermetically sealed space, which forms a “reference pressure chamber”, communicates with the second passage 14 via the communication hole 25. The pressure and temperature of refrigerant passing through the second passage 14 are transmitted to an underside of the diaphragm 28 by way of the communication hole 25 and grooves provided in the disk 29. This pressure receiving structure by the diaphragm 28 constitutes a “drive section”. A seal structure by which to prevent the leakage of refrigerant is provided in between the power element 3 and the body 2. The seal structure will be discussed later in detail.

A stepped hole 34 that connects the first passage 13 to the second passage 14 is provided in a central part of the body 2, and an elongated shaft 33 (which functions as an “actuating rod”) is slidably inserted into a smaller-diameter part 44 of the stepped hole 34. The shaft 33 is set between the disk 29 and the valve element 18. With this structure and arrangement, a drive force generated by a displacement of the diaphragm 28 is transmitted to the valve element 18 by way of the disk 29 and the shaft 33 so as to open and close the valve section.

An upper half of the shaft 33 moves across the second passage 14, whereas a lower half thereof slidably penetrates the smaller-diameter part 44 of the stepped hole 34. A vibration-proof spring 50 is placed in a larger-diameter part 46 of the stepped hole 34; the larger-diameter part 46 thereof corresponds to “hole section”. The vibration-proof spring 50 is used to exert a biasing force, whose direction is vertical to the direction of axis line, on the shaft 33; in other words, the vibration-proof spring is used to exert a lateral load (sliding load) on the shaft 33. As the shaft 33 receives the lateral load of the vibration-proof spring 50, the vibration of the shaft 33 and the valve element 18 caused by a change in the refrigerant pressure is suppressed or inhibited. The vibration-proof spring 50 is formed such that a band-like plate made of metal, having a high elasticity, such as stainless steel, is bent and processed at a plurality of positions along the extending direction. A spring part is integrally molded at each of a plurality of side walls of the vibration-proof spring 50. The spring parts are warped outwardly when the shaft 33 is inserted to the vibration-proof spring 50, and an elastically reactive force thereby creates an appropriate sliding force on the shaft 33, so that the shaft 33 can slide in a stabilized manner.

As shown in FIG. 2, the adjustment screw 20 has a hexagon socket 52 on a bottom face thereof, and a pin 54 is mounted upright on a center of the bottom face of the hexagon socket 52 and extends downward. In other words, the adjustment screw 20 according to the present embodiment cannot be turned or rotated unless a special tool is used. Here, the special tool as used herein has a hole through which to insert the pin 54 to a center of a distal end face of a hexagonal wrench. In this manner, the adjustment screw 20 is configured such that it cannot be rotated by using a normal wrench. This configuration prevents the valve opening characteristics of the expansion valve 1 from being altered by an accidental or ill-intended turning of the adjustment screw 20. Although, in the present embodiment, the shape of the hole into which the special tool is required for the mounting is hexagonal, the shape thereof is not limited thereto and other shapes such as a pentagon may be used to fit into any other special tools.

In the expansion valve 1 configured as above, the power element 3 senses the pressure and temperature of refrigerant returned from the evaporator through the lead-in port 8, which in turn causes the diaphragm 28 to develop a displacement. The displacement of the diaphragm 28 becomes a drive force, and this drive force is transmitted to the valve element 18 via the disk 29 and the shaft 33 so as to open or close the valve section. At the same time, the liquid refrigerant fed from the receiver is led through the lead-in port 6 and is then throttled and expanded by passing through the valve section so as to become a low-temperature and low-pressure misty refrigerant. This misty refrigerant is led out through the lead-out port 7 toward the evaporator.

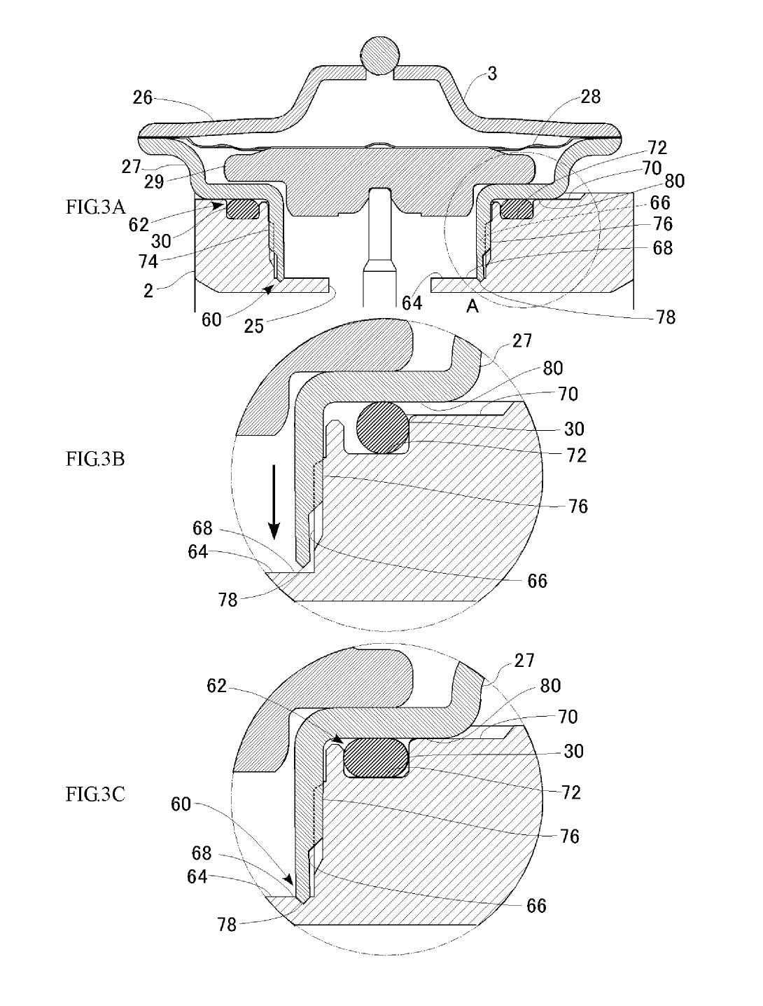

A description is now given of the seal structure provided between the power element 3 and the body 2. FIGS. 3A to 3C show structures of seal parts and their peripheries. FIG. 3A is an enlarged view of an upper portion of FIG. 1. FIG. 3B and FIG. 3C are each an enlarged view of an encircled region A in FIG. 3A, and each shows a process for forming the seal part.

As shown in FIG. 3A, in the present embodiment, as for the joining of the lower housing 27 of the power element 3 and the body 2, a metal seal part 60 is provided radially inward, whereas an elastic seal part 62 is provided radially outward.

A circular recess 64 having a predetermined depth is formed in an upper center of the body 2, and an internal thread 66 is formed in an inner circumferential surface of the recess 64. The above-described communication hole 25 is provided in a bottom center of the recess 64, and a bottom peripheral edge thereof constitutes a seal formation surface 68. A stopper surface 70 is formed, by a counter boring, on a top face of the body 2.

In the present embodiment, a bottom face of the recess 64 (i.e., the seal formation surface 68) and the stopper surface 70 are simultaneously formed by using a single cutting tool (e.g., an end mill with a stepped blade). Thus, the height of the stopper surface 70 relative to the seal formation surface 68 is managed and controlled with high accuracy. Also, a circular fitting-groove 72 formed concentrically about the center of the recess 64 is formed in the stopper surface 70, and an O-ring 30 is fitted into the fitting-groove 72.

Also, the lower housing 27 is of a stepped cylindrical shape such that the diameter thereof is reduced downward in stages, and a lower half thereof constitutes a cylindrical fitting section 74. An external thread 76 screwable with the internal thread 66 is formed in an outer circumferential surface of the cylindrical fitting section 74. The lower housing 27 is mounted on the body 2 in a manner such that the cylindrical fitting section 74 is threaded into the recess 64. A lower end of the cylindrical fitting section 74 is a protrusion 78 that is shaped in a sharp edge by a cutting work. A base end of the cylindrical fitting section 74 in the lower housing 27 is a stopper surface 80, which is vertical to the axis line, and is configured such that the base end thereof is contactable with the stopper surface 70 of the body 2.

When the power element 3 is to be assembled to the body 2, the lower housing 27 is threaded into the recess 64, as shown in FIG. 3B, with the O-ring 30 being fitted into the fitting-groove 72. Thereby, while the O-ring 30 is being pressed flat against the stopper surface 80, the O-ring 30 is attached firmly to both the power element 3 and the body 2. This process forms the elastic seal part 62. As the lower housing 27 is threaded thereinto in this manner, the protrusion 78 finally comes into contact with the seal formation surface 68. At a stage where the protrusion 78 is about to come into contact therewith (see FIG. 3B), there is still a gap between the stopper surface 80 and the stopper surface 70. In this state, the lower housing 27 is further threaded thereinto. As a result, as shown in FIG. 3C, the protrusion 78 having a relatively higher degree of hardness bites into the seal formation surface 68 having a relatively lower degree thereof and consequently the protrusion 78 and the seal formation surface 68 are joined together such that the seal formation surface 68 is partially crushed (namely, compressed and deformed). When, in this manner, the stopper surface 80 abuts against the stopper surface 70 and consequently the lower housing 27 is stopped by the body 2, a preset biting amount (penetration quantity) is reached. This forms the metal seal part 60.

As described above, in the expansion valve according to the present embodiment, as for the joining of the lower housing 27 of the power element 3 and the body 2, the metal seal part 60 is provided radially inward, whereas the elastic seal part 62 is provided in radially outward. The metal seal part 60 prevents the refrigerant from being permeated and then leaked to the outside space. At the same time, the elastic seal part 62 prevents moisture in the outside space from entering the metal seal part 60. As a result, the electric corrosion at the joint part of the lower housing 27 and the body 2 is prevented. In other words, the configuration is implemented where the O-ring (elastic seal) through which the refrigerant may possibly be permeated and finally leaked is placed outside and therefore the elastic seal never comes into contact with the refrigerant; the O-ring (elastic seal) can prevent the moisture from entering the metal seal and therefore can prevent the electric corrosion of the metal seal. A double structure not assumed in the conventional practice is used where the metal seal part 60 and the elastic seal part 62 provided inside and outside, respectively, are used in combination. Thereby, the sealing property at the joint part of the power element 3 and the body 2 can be improved.

Also, in the present embodiment, the biting amount of the lower housing 27 to the seal formation surface 68 can be properly set by setting the height of the stopper surface 70 relative to the seal formation surface 68 in the body 2. In other words, a proper and appropriate metal seal is achieved if the stopper surface 80 of the lower housing 27 is threaded until the stopper surface 80 thereof comes into contact with the stopper surface 70 when the power element 3 is to be assembled to the body 2. As a result, the assembly work is made easy.

### Second Embodiment

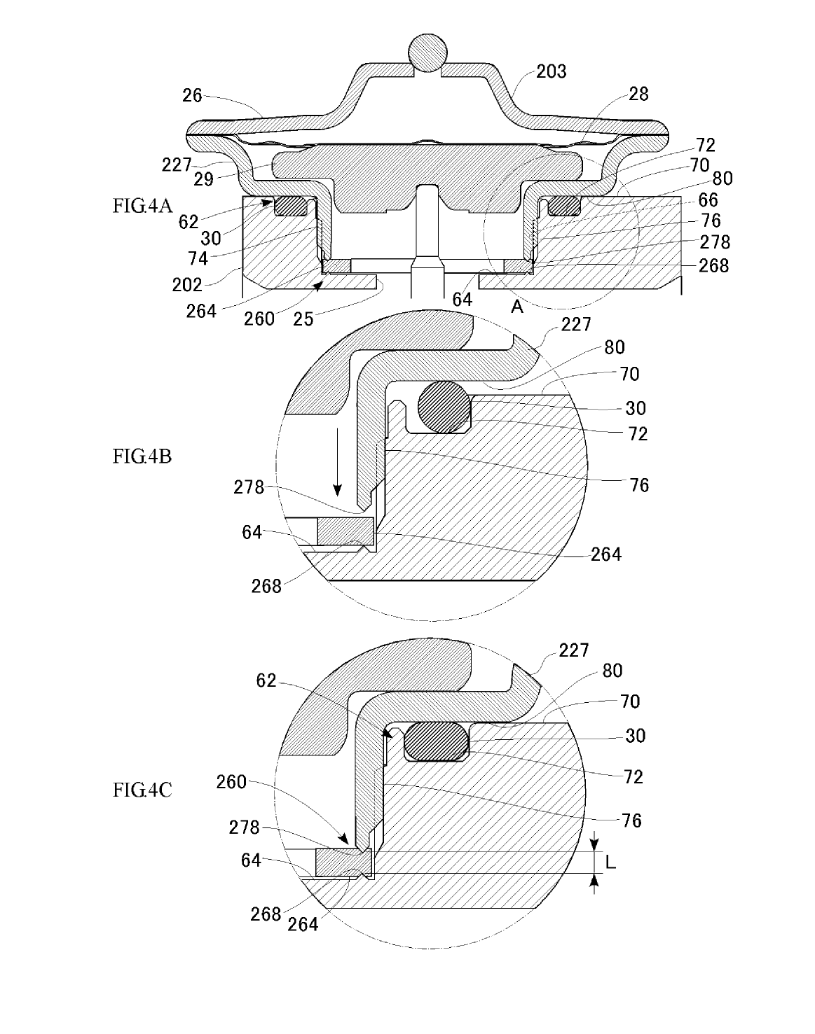

An expansion valve according to a second embodiment is configured the same way as the first embodiment excepting that the metal seal is achieved by way of a metal gasket. Thus, a description is hereinbelow given centering around different features from the first embodiment. FIGS. 4A to 4C show structures of seal parts and their peripheries. FIG. 4A is an enlarged view of an upper portion of the expansion valve. FIG. 4B and FIG. 4C are each an enlarged view of an encircled region A in FIG. 4A, and each shows a process for forming a seal part.

As shown in FIG. 4A, in the present embodiment, a circular protrusion 268 (which functions as “first circular protrusion”) is provided on a bottom face of the recess 64 in a body 202. The protrusion 268, which is of an annular shape, is formed in a position that faces a circular protrusion 278 (which functions as “second circular protrusion”) formed at a lower end of a power element 203. A ring-shaped metal gasket 264 is set between the bottom face of the recess 64 and a lower housing 227.

The metal gasket 264 is formed of a metal (e.g., a copper alloy or an aluminum alloy), whose Vickers hardness is 50 Hv or below, and the hardness of the metal gasket 264 is lower than that of the lower housing 227 and that of the body 202. Accordingly, when the power element 203 is fastened to the body 202, the metal gasket 264 is held between the protrusion 268 and the protrusion 278 and then the top face and the bottom face of the metal gasket 264 are partially and circularly pressed against the protrusion 268 and the protrusion 278, respectively, and are jointed thereto. This forms the metal seat part 260. The thickness of the metal gasket 264 is such that the distance between the tip of the protrusion 268 and the tip of the protrusion 278 in the metal gasket 264 becomes L (see FIG. 4C) in a state where the assembly of the power element 203 to the body 202 has been completed, namely in a state where the lower housing 227 is stopped by the body 202.

When the power element 203 is to be assembled to the body 202, the metal gasket 264 is placed on the bottom face of the recess 64 and then the lower housing 227 is threaded into the recess 64, as shown in FIG. 4B, with the O-ring 30 being fitted into the fitting-groove 72. Thereby, the protrusion 278 comes into contact with the metal gasket 264. This causes the metal gasket 264 to be held between the protrusion 278 and the protrusion 268. In this state, the lower housing 227 is further threaded thereinto. As a result, as shown in FIG. 4C, the protrusions 278 and 268 both having a relatively higher degree of hardness bite into the top face and the bottom face of the metal gasket 264, having a relatively lower degree thereof, respectively. And consequently the protrusions 278 and 268 and the metal gasket 264 are joined together such that the metal gasket 264 is partially crushed (namely, compressed and deformed). This forms the metal seal part 260.

As described above, in the expansion valve according to the present embodiment, too, as for the joining of the lower housing 227 of the power element 203 and the body 202, the metal seal part 260 is provided radially inward, whereas the elastic seal part 62 is provided in radially outward. Thus, the sealing property at the joint part of the power element 203 and the body 202 can be enhanced because of this double structure realized by the metal seal part 260 and the elastic seal part 62. Also, since the configuration is such that the metal gasket 264 is set between the protrusion 278 and the protrusion 268, it is no longer necessary to strictly manage the height of the stopper surface 70 relative to the bottom face of the recess 64 as long as the aforementioned distance L is ensured. In other words, since a small dimension error can be absorbed by the thickness of the metal gasket 264, the design can be done easier. Thus, the counter boring on the top face of the body 202 carried out in the first embodiment is no longer carried out in the second embodiment.

### Third Embodiment

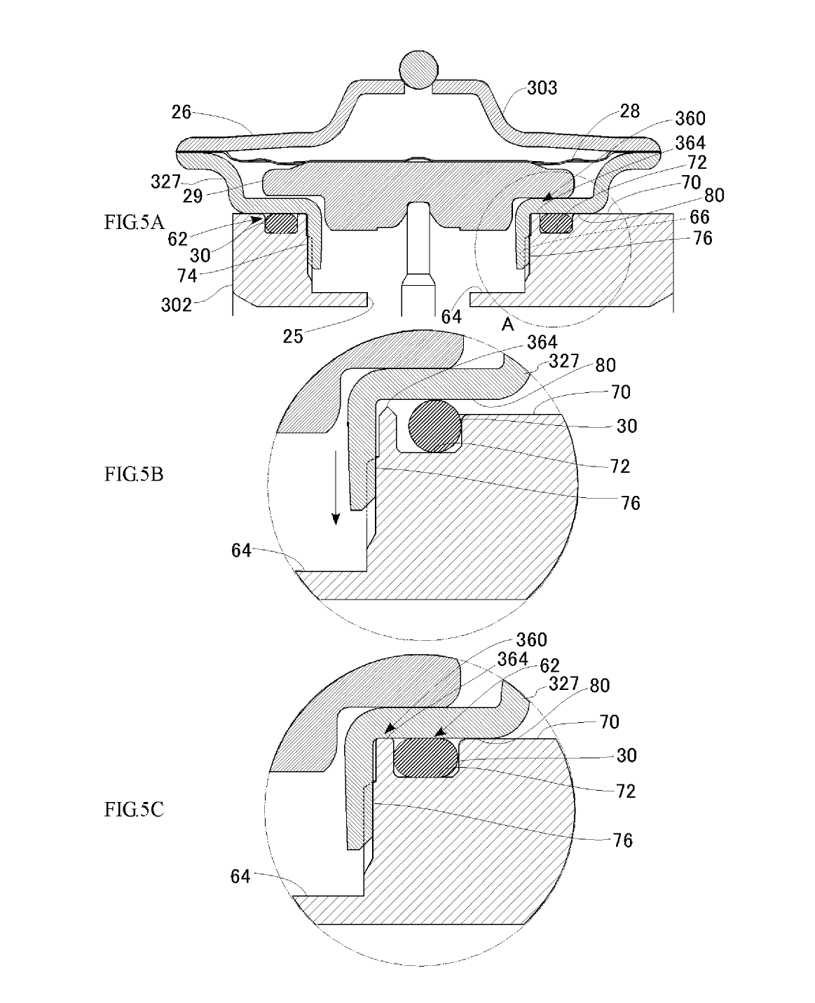

An expansion valve according to a third embodiment is configured the same way as the first embodiment excepting that the metal seal is achieved by crushing (compressing and deforming) a circular protrusion provided on a body side. Thus, a description is hereinbelow given centering around different features from the first embodiment. FIGS. 5A to 5C show structures of seal parts and their peripheries. FIG. 5A is an enlarged view of an upper portion of the expansion valve. FIG. 5B and FIG. 5C are each an enlarged view of an encircled region A in FIG. 5A, and each shows a process for forming a seal part.

As shown in FIG. 5A, in the present embodiment, a metal seal part 360 is formed such that a circular protrusion 364 (which functions as “circular protrusion”) provided in an upper end opening of the recess 64 is joined to a lower housing 327. The protrusion 364 forms an inward wall surface in the fitting-groove 72.

When a power element 303 is to be assembled to a body 302, the lower housing 327 is threaded into the recess 64, as shown in FIG. 5B, with the O-ring 30 being fitted into the fitting-groove 72. A tip of the protrusion 364 has a sharply-pointed shape in the beginning of an assembly process. In this state, the lower housing 327 is further threaded thereinto. As a result, as shown in FIG. 5C, the protrusion 364 having a relatively low degree of hardness is crushed (namely, compressed and deformed) by the lower housing 327 having a relatively higher degree thereof and consequently the body 302 and the lower housing 327 are joined together. This forms the metal seal part 360.

As described above, in the expansion valve according to the present embodiment, too, as for the joining of the lower housing 327 of the power element 303 and the body 302, the metal seal part 360 is provided radially inward, whereas the elastic seal part 62 is provided in radially outward. Thus, the sealing property at the joint part of the power element 303 and the body 302 can be enhanced because of this double structure realized by the metal seal part 360 and the elastic seal part 62.

The description of the present invention given above is based upon illustrative embodiments. These embodiments are intended to be illustrative only and it will be obvious to those skilled in the art that various modifications could be further developed within the technical idea underlying the present invention.

In the first embodiment, the counter boring is conducted for the purpose of forming the stopper surface 70 on the top face of the body 2. However, this counter boring processing may be skipped.

In the above-described embodiments, the elastic seal part is constituted by the O-ring. This should not be considered as limiting, and a sealing member formed of other elastic bodies such as rubber packing may be used, instead.

In the above-described embodiments, the description has been given of an example where the body is formed by an aluminum alloy and the housing of the power element is formed by stainless steel. However, different metals may be used respectively. For example, the housing may be formed by a copper alloy. It is preferable, however, that the body and the housing are formed of different metals from each other and that the quality of the materials be selected such that the degree of hardness of the housing is higher than that of the body.

The expansion valves according to the above-described embodiments are suitably applied to and used for a refrigeration cycle where hydrochlorofluorocarbon (HFC-134a, HFO-1234yf and so forth) is used as the refrigerant. Also, the expansion valves according to the present embodiments and their modifications may be applied to a refrigeration cycle where a refrigerant, such as carbon dioxide, whose working pressure is high is used. In such a case, an external heat-exchanger such as a gas cooler may be placed in the refrigerant cycle, instead of the condenser. In this case, a plurality of disk springs formed of a metal, for example, may be disposed in superposition for the purpose of reinforcing the diaphragm constituting the power element. Or alternatively, the disc springs or the like may be provided in place of the diaphragm.

In the above-described embodiments, an example is described where the expansion valve is configured as a thermostatic expansion valve. However, the expansion valve according to the present embodiments may also be configured as one that does not sense the temperature. For example, the expansion valve may be configured as an electromagnetic expansion valve that uses a solenoid as the drive section. Or alternatively, the expansion valve may be configured as an electric expansion valve that uses an electric motor as the drive section. In such a case, the opening end of the body will be sealed by a casing (metallic casing) of the solenoid or a stepping motor. Thus, similar to the above-described embodiments, the metal seal part may be provided inside at the joint part of the casing and the body, and the elastic seal part may be provided outside.

The present invention is not limited to the above-described embodiments and modifications only, and those components may be further modified to arrive at various other embodiments without departing from the scope of the invention. Also, various other embodiments may be further formed by combining, as appropriate, a plurality of structural components disclosed in the above-described embodiments and modifications. Also, one or some of all of the components exemplified in the above-described embodiments and modifications may be left unused or removed.

What is claimed is:

1. An expansion valve that throttles and expands refrigerant introduced from an upstream side of a refrigeration cycle by allowing the refrigerant to pass through a valve section so as to deliver the refrigerant to a downstream side thereof, the expansion valve comprising:
a metallic body having a lead-in port through which the refrigerant is led in, a lead-out port through which the refrigerant is led out, and a valve hole formed in a refrigerant passage joining the lead-in port to the lead-out port;
a valve element that opens and closes the valve section by moving toward and away from the valve hole;
a power element having a housing formed of a metal different from a kind of metal constituting the body and a drive section, provided within the housing, which generates a drive force used to open and close the valve section, wherein the power element is fixed to the body in a manner such that the housing closes an opening end part of the body;
a metal seal part, provided between the body and the housing, which seals between an inside space and an outside space thereof by a deformation developed in a metal; and
an elastic seal part, provided between the body and the housing, which seals between an inside and an outside space thereof in such a manner as to surround a periphery of the metal seal part.

2. An expansion valve according to claim 1, wherein the metal seal part is formed such that at least one of the body and the housing is deformed at surfaces thereof.

3. An expansion valve according to claim 2, wherein the housing is formed of a metal whose degree of hardness is higher than that of the body, and the housing has a cylindrical fitting section that is inserted to an opening end of the body while the cylindrical fitting section being threadably mounted to the body, and
wherein, when the housing is fastened to the body, the metal seal part is formed in such a manner that a part of the body is compressed and deformed by an opening end of the cylindrical fitting portion.

4. An expansion valve according to claim 3, wherein the housing has a stopper surface that abuts against and is stopped by an end surface of the body, and the housing has the cylindrical fitting section in a position toward a tip side thereof than the stopper surface,
wherein the body has a recess through which the cylindrical fitting section is inserted inside the end surface thereof, and a bottom face of the recess constitute a seal formation surface that receives the opening end of the cylindrical fitting section, and
wherein a biting amount of the cylindrical fitting section to the seal formation surface is set by setting a height of the stopper surface measured from the seal formation surface.

5. An expansion valve according to claim 2, wherein the housing is formed of a metal whose degree of hardness is higher than that of the body,
wherein a circular protrusion is provided on a surface of the body facing the housing, and
wherein, when the housing is assembled to the body, the metal seal part is formed in such a manner that a tip of the circular protrusion is compressed and deformed.

6. An expansion valve according to claim 1, wherein a first circular protrusion is provided on a surface of the body facing the housing,
wherein a second circular protrusion is provided on a surface of the housing facing the body,
wherein a gasket, whose degree of hardness is lower than that of the body and that of the housing, is set between the first circular protrusion and the second circular protrusion, and
wherein the metal seal part is formed in such a manner that the gasket is partially compressed and deformed at both surfaces of the gasket facing the first circular protrusion and the second circular protrusion.

7. An expansion valve according to claim 1, wherein the body is formed of an aluminum alloy, and the housing is formed of stainless steel.

8. An expansion valve according to claim 2, wherein the body is formed of an aluminum alloy, and the housing is formed of stainless steel.

9. An expansion valve according to claim 3, wherein the body is formed of an aluminum alloy, and the housing is formed of stainless steel.

10. An expansion valve according to claim 5, wherein the body is formed of an aluminum alloy, and the housing is formed of stainless steel.

11. An expansion valve according to claim 1, wherein the expansion valve is configured as a thermostatic expansion valve which delivers the throttled and expanded refrigerant, having passed through the valve section, from the lead-out port and supplies the refrigerant to an evaporator and which controls a valve opening degree of the valve section by sensing a pressure and a temperature of the refrigerant returned from the evaporator,
the expansion valve including:
a return passage, formed separately from the refrigerant passage in such a manner as to run through the body, the return passage having the refrigerant returned from the evaporator pass therethrough; and
an actuating rod, supported by the body in such a manner as to penetrate the return passage, which transmits the drive force of the power element to the valve element;
wherein the power element is enabled upon sensing temperature and pressure of the refrigerant flowing through the return passage and controls a flow rate of refrigerant supplied to the evaporator by transmitting the drive force to the valve element via the actuating rod and varying the valve opening degree of the valve section.

12. An expansion valve according to claim 2, wherein the expansion valve is configured as a thermostatic expansion valve which delivers the throttled and expanded refrigerant, having passed through the valve section, from the lead-out port and supplies the refrigerant to an evaporator and which controls a valve opening degree of the valve section by sensing a pressure and a temperature of the refrigerant returned from the evaporator,
the expansion valve including:
a return passage, formed separately from the refrigerant passage in such a manner as to run through the body, the return passage having the refrigerant returned from the evaporator pass therethrough; and
an actuating rod, supported by the body in such a manner as to penetrate the return passage, which transmits the drive force of the power element to the valve element;
wherein the power element is enabled upon sensing temperature and pressure of the refrigerant flowing through the return passage and controls a flow rate of refrigerant supplied to the evaporator by transmitting the drive force to the valve element via the actuating rod and varying the valve opening degree of the valve section.

13. An expansion valve according to claim 6, wherein the expansion valve is configured as a thermostatic expansion valve which delivers the throttled and expanded refrigerant, having passed through the valve section, from the lead-out port and supplies the refrigerant to an evaporator and which controls a valve opening degree of the valve section by sensing a pressure and a temperature of the refrigerant returned from the evaporator,
the expansion valve including:
a return passage, formed separately from the refrigerant passage in such a manner as to run through the body, the return passage having the refrigerant returned from the evaporator pass therethrough; and
an actuating rod, supported by the body in such a manner as to penetrate the return passage, which transmits the drive force of the power element to the valve element;
wherein the power element is enabled upon sensing temperature and pressure of the refrigerant flowing through the return passage and controls a flow rate of refrigerant supplied to the evaporator by transmitting the drive force to the valve element via the actuating rod and varying the valve opening degree of the valve section.
